(19) United States
(12) Patent Application Publication
(10) Pub. No.: US 2023/0312251 A1
(43) Pub. Date: Oct. 5, 2023

(54) SYSTEMS AND METHODS FOR HANDLING PARTICULATE MATERIAL

(71) Applicant: Bowlin Enterprises, LLC, Shreveport, LA (US)

(72) Inventor: Jon BOWLIN, Benton, LA (US)

(73) Assignee: Bowlin Enterprises, LLC, Shreveport, LA (US)

(21) Appl. No.: 18/121,501

(22) Filed: Mar. 14, 2023

Related U.S. Application Data
(60) Provisional application No. 63/336,791, filed on Apr. 29, 2022.
(60) Provisional application No. 63/327,204, filed on Apr. 4, 2022.

(51) Int. Cl. B65G 11/08; B65G 11/20; B65G 69/18

(52) U.S. Cl. CPC B65G 11/083; B65G 11/206; B65G 69/181; E21B 43/2607

(57) ABSTRACT

A system for handling particulate material includes a chute. The chute includes a main conduit and first and second branch conduits that extend from the main conduit. The chute includes a flow adjuster configured to alter a flow distribution of the particulate material between the first and second branch conduits. In an example operation, first and second containers are placed onto a shuttle on a transfer conveyor. The transfer conveyor moves the shuttle with the first and second containers beneath the chute to place the first container under the first branch conduit and the second container under the second branch conduit. The containers are loaded with particulate material distributed through the chute. Then the containers are moved away from the chute.

### CROSS-REFERENCE TO RELATED APPLICATIONS

This application claims benefit of United States provisional pat. application serial number 63/327,204; filed on Apr. 4, 2022. This application claims benefit also of United States provisional pat. application serial number 63/336,791; filed on Apr. 29, 2022. Both application serial number 63/327,204 and application serial number 63/336,791 are incorporated herein by reference in their entireties.

### BACKGROUND

### Field

Embodiments of the present disclosure generally relate to systems and methods employed at a work location, such as a well site, for handling particulate material, such as sand.

### Description of the Related Art

Particulate material in various forms is used in many industries, such as mining, construction, food processing and distribution, and ore processing. One example is the oil and gas industry, in which particulate material is used in hydraulic fracturing operations in wells. The particulate material, in the form of engineered ceramic particles, sand, or other particles, is pumped as a slurry into a well, and into fractures within the rock into which the well has been drilled. In the oil and gas industry, the particulate material is often referred to as proppant.

As an example, a typical fracturing operation may use as much as from about 1,000 to about 2,500 tons of proppant in a day, and from about 2,500 to about 20,000 tons of proppant per well. The need for such quantities presents logistical challenges with the delivery and handling of the proppant at a well site. In some fracturing operations, proppant is supplied pre-loaded into discrete containers that are stacked at the wellsite. Typically, the containers are provided in two sizes. The larger size usually holds up to about 20 tons of wet sand or up to about 25 tons of dry sand. The smaller size usually holds up to about 10 tons of wet sand or up to about 13 tons of dry sand. The containers are transported on trailers. Typically, a truck with a trailer can transport only a single fully-loaded larger-sized container or two fully-loaded smaller-sized containers. Consequently, a typical fracturing operation may entail the stacking and moving of many containers at the well site, which takes up space, and requires a continual cycle of trucks to deliver loaded containers and remove empty containers. During an example fracturing operation, many tens of empty containers may be stacked awaiting removal, which requires the allocation of space at the well site that can be limited.

Thus, there is a need for equipment and methods to alleviate the logistical challenges of handling large quantities of proppant at a well site. Such a need is mirrored in other industries in which large quantities of particulate material are handled at a work location.

### SUMMARY

The present disclosure generally relates to systems and methods employed at a work location, such as a well site, for handling particulate material, such as sand. The particulate material is loaded into containers.

In one embodiment, a system for handling particulate material includes a chute. The chute includes a main conduit, a first branch conduit, and a second branch conduit. The first branch conduit extends from the main conduit, and terminates at a first spout. The second branch conduit extends from the main conduit, and terminates at a second spout. The system includes a feed conveyor configured to discharge the particulate material into the main conduit. A first lift is disposed below the first spout, and is configured to raise a first container toward the first spout. A second lift is disposed below the second spout, and is configured to raise a second container toward the second spout. The system includes a transfer conveyor system configured to move the first and second containers between a first position away from the chute and a second position in which the first container is beneath the first spout and the second container is beneath the second spout.

In another embodiment, a system for handling containers includes a frame and a transfer conveyor mounted to the frame. The transfer conveyor includes a pair of parallel elongated channels. A shuttle is disposed on the transfer conveyor. The shuttle includes a base configured to receive a container. The shuttle further includes a pair of channel keys extending from the base, each channel key projecting into a corresponding one of the pair of channels. The system further includes a lift mounted to the frame, the lift including first and second lift units configured to raise a container off the base and lower the container onto the base.

In another embodiment, a method of handling particulate material includes placing first and second containers onto a transfer conveyor system at a predetermined separation, and operating the transfer conveyor system to move the first container to a location beneath a first spout of a chute, and to move the second container to a location beneath a second spout of the chute. The method includes lifting the first container off the transfer conveyor system and toward the first spout using a first lift, and lifting the second container off the transfer conveyor system and toward the second spout using a second lift. The method includes discharging the particulate material from a feed conveyor into a main conduit of the chute, and diverting a first portion of the particulate material in the main conduit into a first branch conduit, and a second portion of the particulate material in the main conduit into a second branch conduit. The method includes discharging the first portion into the first container through the first spout, and the second portion into the second container through the second spout, and monitoring a first weight of the particulate material in the first container and a second weight of the particulate material in the second container. The method includes lowering the first and second containers back onto the transfer conveyor system, and operating the transfer conveyor system to move the first and second containers away from the chute.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, as the disclosure may admit to other equally effective embodiments.

FIG. 1 is a schematic plan view of a particulate material handling system.

FIGS. 2A and 2B are schematic side views of the system of FIG. 1.

FIG. 2C is a schematic cross-sectional side view of a component of the system of FIG. 1.

FIG. 2D is a schematic cross-sectional side view of an alternative configuration of the component of FIG. 2C.

FIG. 2E is a schematic cross-sectional side view of an alternative configuration of a component depicted in FIG. 2B.

FIGS. 3A-3C schematically illustrate an exemplary operation of portions of the system of FIG. 1.

FIGS. 4A-4C schematically illustrate an exemplary operation of an alternative configuration of the portions depicted in FIGS. 3A-3C.

FIGS. 5A-5C schematically illustrate an exemplary operation of another alternative configuration of the portions depicted in FIGS. 3A-3C.

FIGS. 6A and 6B schematically illustrate an exemplary embodiment of a portion of the particulate material handling system of FIG. 1.

FIGS. 7A-7D schematically illustrate an exemplary operation of the particulate material handling system of FIG. 1 incorporating the embodiment of FIGS. 6A and 6B.

FIGS. 8A-8C schematically illustrate an exemplary embodiment of a portion of the particulate material handling system of FIG. 1.

FIGS. 9A-9F schematically illustrate an exemplary operation of the particulate material handling system of FIG. 1 incorporating the embodiment of FIGS. 8A-8C.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns systems and methods for handling particulate material. The particulate material can be any material existing as discrete elements, such as sand; gravel; coal; ore; pulverized scrap materials; wood chips; agricultural products, such as fruits, vegetables, grains, or legumes; and the like. The systems and methods of the present disclosure can be used to handle particulate material including relatively small discrete elements, such as sand grains, wheat grains, or the like. The systems and methods of the present disclosure can be used to handle particulate material including relatively large discrete elements, such as rubble; food produce, such as potatoes; or the like. The systems and methods of the present disclosure can be used to handle dry particulate material (such as including less than about 2% free water by weight), damp particulate material (such as including about 2% to about 6% free water by weight), or wet particulate material (such as including more than about 6% free water by weight). The systems and methods of the present disclosure can be used in various industries, such as mining; construction; waste processing and recycling; food processing and distribution; minerals extraction and processing; and oil and gas.

The systems of the present disclosure facilitate the reception of particulate material delivered in bulk at a work site, and the distribution of the particulate material into containers at the work site. The containers may be boxes or other receptacles configured for holding particulate material. During an operation at the work site, the containers loaded with the particulate material become empty, and are refilled at the work site. The refilling and reuse of the containers at the work site results in cost savings in the total number of containers needed for an operation and savings of space that otherwise would have to be used for the stacking of empty containers. In an example, the work site is a well site, and the particulate material is proppant, such as sand, for use in wellbore fracturing. In such an example, the delivery of the particulate material in bulk, rather than via discrete containers, enables the delivery to be accomplished in loads of up to 30 tons per truck (dry sand or wet sand) instead of up to only 25 tons per truck (dry sand) or up to only 20 tons per truck (wet sand), which provides savings in the numbers of trucks required to supply particulate material for the operation.

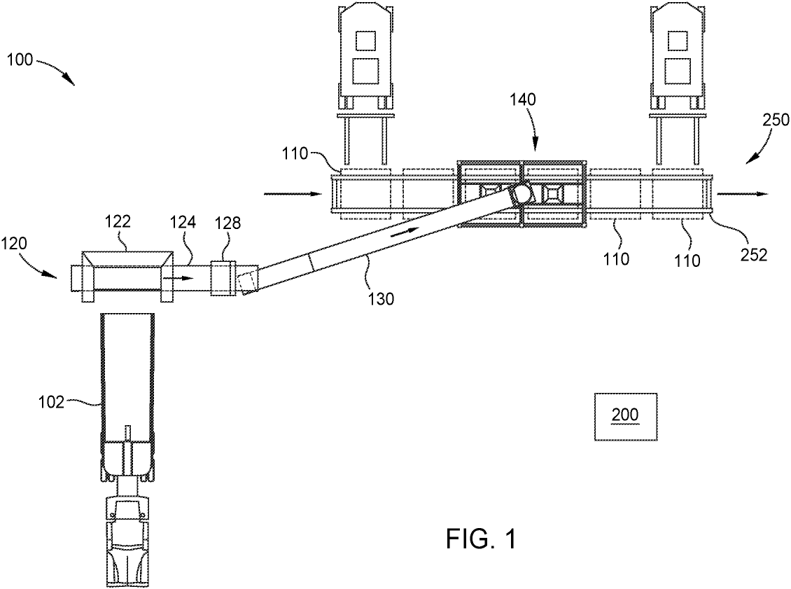

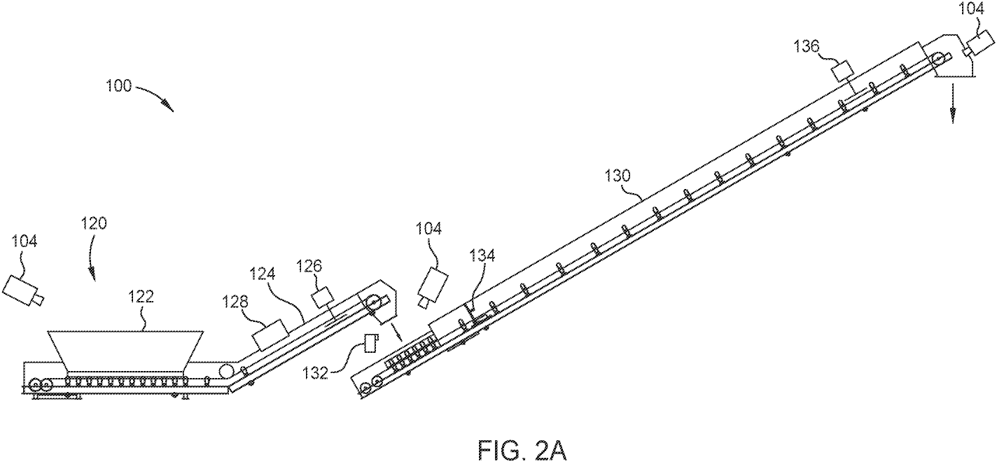

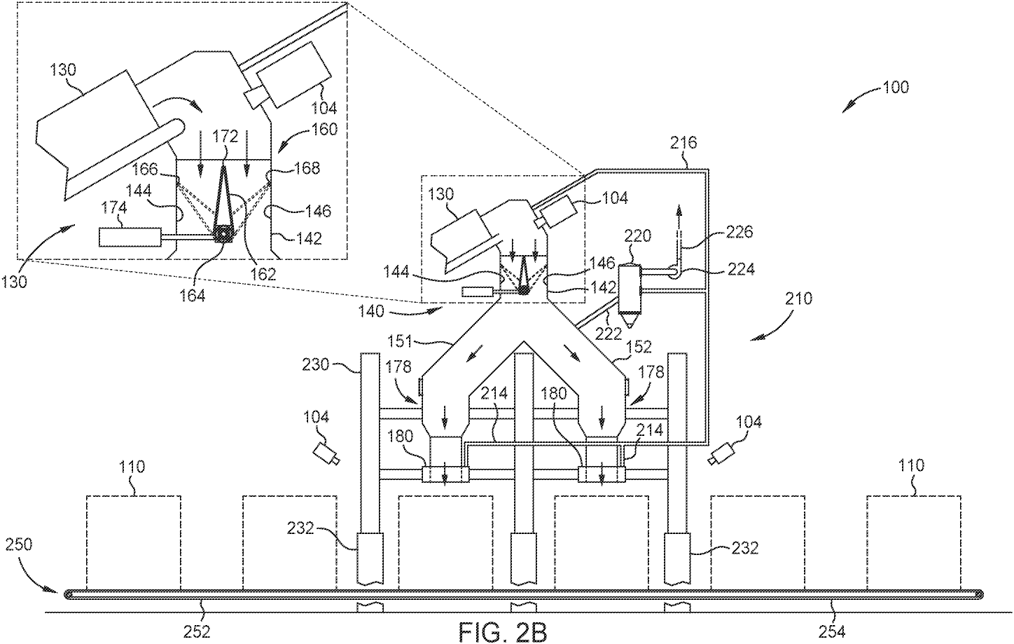

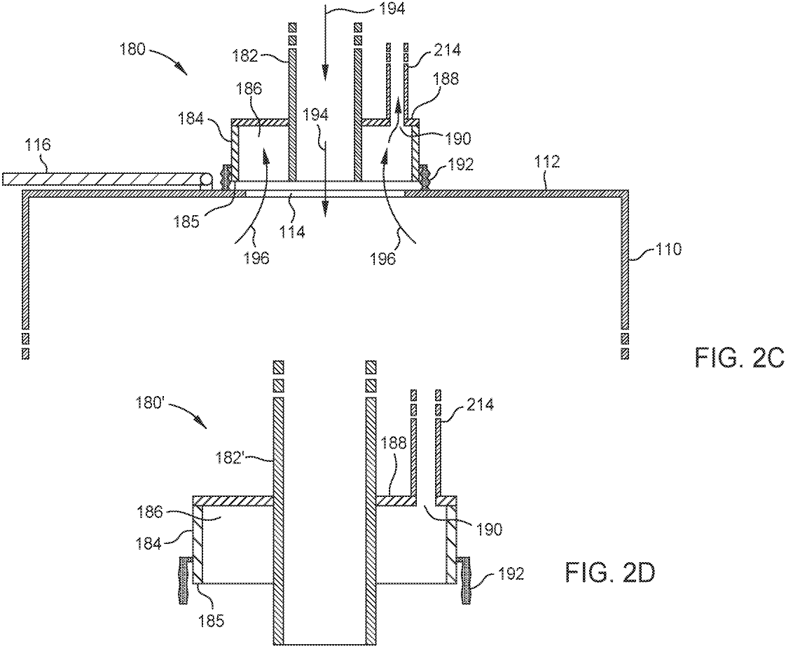

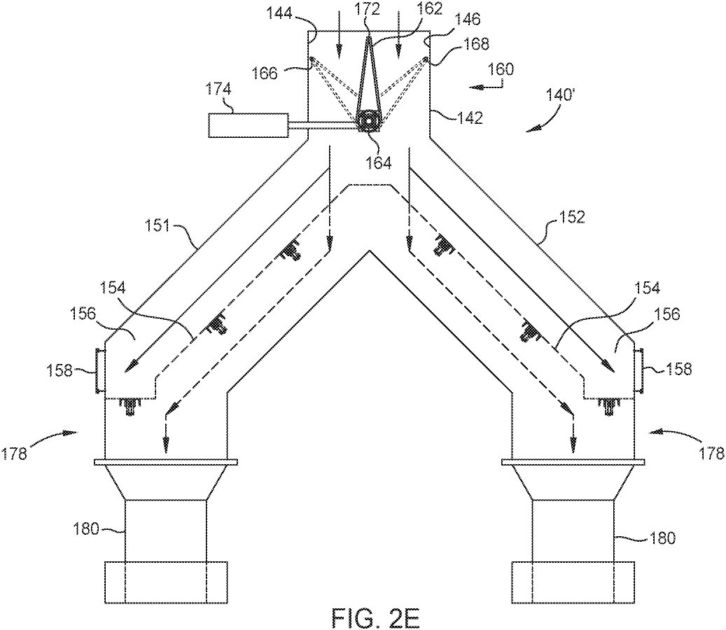

FIG. 1 is a schematic plan view of a particulate material handling system 100. FIGS. 2A and 2B are schematic side views of the system 100. As illustrated in FIGS. 1 and 2A, the system 100 includes an unloader 120. The unloader 120 includes a hopper 122, into which particulate material, such as sand or any other particulate material as discussed above, is discharged from a supply such as a truck 102. The hopper 122 directs the particulate material onto an unloading conveyor 124. The unloading conveyor 124 may be any suitable type of conveyor, such as a belt conveyor, pocket belt conveyor, bucket elevator, screw conveyor, pneumatic conveyor, or a tubular drag disc conveyor. The adjustment of an operating speed of the unloading conveyor 124 facilitates the regulation of a feed rate of the particulate material to subsequent stages of the system 100.

In some embodiments, the unloading conveyor 124 includes a scale 126 that provides measurements of the weight of particulate material being carried by the unloading conveyor 124. The scale 126 may provide a continuous measurement of weight or a measurement of weight at intervals of time, such as every second. Additionally, or alternatively, the unloading conveyor 124 may include a sensor for monitoring the rate of operation of the unloading conveyor 124. The sensor may provide signals that can be correlated to an incremental volume and/or weight of particulate material being delivered by the unloading conveyor 124. In some embodiments, the scale 126 may be omitted.

As illustrated, in embodiments in which the particulate material is nonmagnetic, a magnet 128 positioned above the unloading conveyor 124 removes magnetic material, such as steel nuts and bolts, that may be contaminating the particulate material. In some embodiments, the magnet 128 may be omitted.

In some embodiments, the unloader 120 is configured to facilitate transportation and to facilitate deployment at a work site. In an example, the unloader 120 is mounted on a skid. In another example, the unloader 120 is mounted on a wheeled chassis. In another example, the unloader 120 is mounted on a trailer.

The unloading conveyor 124 discharges the particulate material onto a feed conveyor 130. The feed conveyor 130 may be any suitable type of conveyor, such as a belt conveyor, pocket belt conveyor, bucket elevator, screw conveyor, pneumatic conveyor, or a tubular drag disc conveyor. The adjustment of an operating speed of the feed conveyor 130 facilitates regulation of a feed rate of the particulate material to a subsequent stage of the system 100. In some embodiments, the unloading conveyor 124 and the feed conveyor 130 may be combined into a single unit.

In some embodiments, a moisture meter 132 provides readings of the moisture content of the particulate material. In an example, the moisture meter 132 may be a non-contact moisture meter 132 based on near infrared spectroscopy. As illustrated, in some embodiments, a moisture meter 132 monitors the particulate material being discharged from the unloading conveyor 124. Additionally, or alternatively, a moisture meter 132 may be positioned to monitor the particulate material on the unloading conveyor 124 or on the feed conveyor 130. In some embodiments, the moisture meter 132 may be omitted.

As illustrated, in embodiments in which the particulate material is nonmetallic, a metal detector 134 positioned at the feed conveyor 130 senses metallic material that may be contaminating the particulate material. The metallic material may be nonmagnetic, such as aluminum, or may be metallic material that the magnet 128 at the unloading conveyor 124 failed to remove. The metal detector 134 alerts an operator to the presence of contaminating metallic material; the operator may take corrective actions, such as stopping the feed conveyor 130 and removing the metallic material in response to an alert. In some embodiments, the metal detector 134 may be omitted.

In some embodiments, the feed conveyor 130 includes a scale 136 that provides measurements of the weight of particulate material being carried by the feed conveyor 130. The scale 136 may provide a continuous measurement of weight or a measurement of weight at intervals of time, such as every second. Additionally, or alternatively, the feed conveyor 130 may include a sensor for monitoring the rate of operation of the feed conveyor 130. The sensor may provide signals that can be correlated to an incremental volume and/or weight of particulate material being delivered by the feed conveyor 130. In some embodiments, the scale 136 may be omitted.

As illustrated, one or more cameras 104 can be positioned to enable an operator to visually monitor the operation of discharging particulate material into the unloader 120, discharging particulate material from the unloader 120 onto the feed conveyor 130, and/or discharging particulate material from the feed conveyor 130.

In some embodiments, the feed conveyor 130 is configured to facilitate transportation and to facilitate deployment at a work site. In an example, the feed conveyor 130 is mounted on a skid. In another example, the feed conveyor 130 is mounted on a wheeled chassis. In another example, the feed conveyor 130 is mounted on a trailer.

FIGS. 1 and 2B show the feed conveyor 130 discharges the particulate material into a chute 140. The chute 140 includes two branch conduits 151, 152 that diverge from a main conduit 142. As illustrated, the main conduit 142 is oriented vertically, although other orientations are contemplated. Particulate material from the feed conveyor 130 enters the main conduit 142 before passing through one or both branch conduits 151, 152.

As illustrated, in some embodiments, each branch conduit 151, 152 extends at an acute angle with respect to horizontal. In an example, the acute angle is selected according to the angle of repose of the material to be handled by the chute 140. For example, the acute angle may be selected to be at least as large as the angle of repose of the material to be handled by the chute 140. For instance, if it is contemplated that the chute 140 is to be used to handle damp particulate material on one occasion and dry particulate material on another occasion, the acute angle of each branch conduit 151, 152 may be selected to be at least as large as the maximum angle of repose of the damp particulate material and the dry particulate material. As an illustration in which the particulate material is sand, typical angles of repose are about 30-35 degrees for dry sand and about 40-45 degrees for damp sand; the acute angle of each branch conduit 151, 152 with respect to horizontal may be selected to be at least 45 degrees.

In some embodiments, a flow adjuster 160 located in the main conduit 142 regulates a division of the flow of particulate material between the branch conduits 151, 152. In some embodiments, the flow adjuster 160 includes a plate 162 coupled to an axle 164 such that the plate 162 is movable between first and second positions 166, 168 by pivoting on the axle 164. As illustrated, in some embodiments, when the plate 162 is in the first position 166, an end 172 of the plate 162 distal from the axle 164 is located at a first sidewall 144 of the main conduit 142, and a majority of the flow of particulate material through the main conduit 142 is directed into branch conduit 152. For example, 70% or more, 80% or more, 90% or more, 95% or more, or up to 100% of the flow of particulate material through the main conduit 142 is directed into branch conduit 152. In some embodiments, when the plate 162 is in the second position 168, the end 172 of the plate 162 is located at a second sidewall 146 –opposite the first sidewall 144 –of the main conduit 142, and a majority of the flow of particulate material through the main conduit 142 is directed into branch conduit 151. For example, 70% or more, 80% or more, 90% or more, 95% or more, or up to 100% of the flow of particulate material through the main conduit 142 is directed into branch conduit 151.

In some embodiments, the plate 162 is movable to one or more intermediate positions between the first and positions 166, 168 to adjust the resultant relative flow of particulate material into branch conduits 151, 152. In an example, the positioning of the plate 162 is adjustable such that the plate 162 may be moved to, and be held at, any intermediate position. In another example, the positioning of the plate 162 is adjustable such that the plate 162 may be moved to, and be held at, one or more predetermined intermediate positions. The plate 162 is moved between positions by an actuator 174. In an example, the actuator 174 includes a piston and cylinder. In another example, the actuator 174 includes a motor, such as stepper motor.

Each branch conduit 151, 152 includes a portion 178 oriented substantially vertically, such as at fifteen degrees or less, ten degrees or less, or five degrees or less from vertical. Each substantially vertically-oriented portion 178 terminates at a spout 180. Particulate material flows down each branch conduit 151, 152, exits each branch conduit 151, 152 at the corresponding spout 180, and flows into a container 110. The container 110 may be a box or other receptacle configured for holding particulate material.

FIG. 2C is a schematic cross-sectional side view of a spout 180 in position over a container 110 when particulate material is flowing through the spout 180 into the container 110. The spout 180 is positioned over an opening 114 in the roof 112 of the container 110. The spout 180 includes a central pipe 182, through which the particulate material flows. An outer pipe 184 surrounds the central pipe 182; an annular space 186 exists between the central pipe 182 and the outer pipe 184. An upper end of the outer pipe 184 is attached to the central pipe 182, such as via a top plate 188 (as illustrated) or a cross-over tubing. A port 190 in the top plate 188 (or cross-over tubing) is connected to an exhaust line 214 of a dust extraction system 210, described below.

As illustrated, in some embodiments, a shroud 192 is coupled to, and extends below, the outer pipe 184. The shroud 192 circumscribes the lower end 185 of the outer pipe 184, and is made from a resilient material, such as an elastomer. In some embodiments, the shroud 192 is configured as a bellows. When the spout 180 is positioned to deliver particulate material into the container 110, the shroud 192 contacts the roof 112 of the container 110. In some embodiments, the shroud 192 surrounds the opening 114 in the roof 112. In some embodiments, the shroud 192 deforms axially upon contact with the roof 112. Such axial deformation promotes the maintenance of contact between the shroud 192 and the roof 112.

When particulate material flows through the spout 180 into the container 110 (depicted by arrows 194), air inside the container 110 is displaced. Contact between the shroud 192 and the roof 112 of the container 110 promotes the displaced air to flow out through the opening 114 and into the annular space 186 between the central pipe 182 and the outer pipe 184 (depicted by arrows 196). The air flows through the annular space 186, and out of the outer pipe 184 through the port 190 into the exhaust line 214. The air and any entrained materials, such as dust, is carried into the dust extraction system 210, described below, via the exhaust line 214.

FIG. 2D is a schematic cross-sectional side view of a spout 180′. Spout 180′ is an alternative configuration of spout 180, and may be used in place of spout 180 in any embodiment of system 100 in the present disclosure. Components common to spout 180 and spout 180′ are labeled with the same reference numbers. The spout 180′ is illustrated with a shroud 192 in an extended position, such as when not in contact with a roof 112 of a container 110. In the spout 180′, the central pipe 182′ extends beyond a lower end of the outer pipe 184. When the spout 180′ is in position to deliver particulate material into a container 110, the central pipe 182′ extends through the opening 114 in the roof 112 of the container 110. The extended portion of central pipe 182′ provides a physical separation of the particulate material and the displaced air at the opening 114 in the roof 112, which facilitates a flow of the displaced air out of the container 110 by reducing air turbulence at the opening 114.

FIG. 2E is a schematic cross-sectional side view of a chute 140′. Chute 140′ is an alternative configuration of chute 140, and may be used in place of chute 140 in any embodiment of system 100 in the present disclosure. Components common to chute 140 and chute 140′ are labeled with the same reference numbers. Chute 140′ includes a main conduit 142 coupled to branch conduit 151 and branch conduit 152. Particulate material from the feed conveyor 130 enters the main conduit 142 before passing through one or both branch conduits 151, 152. In some embodiments, a flow adjuster 160 located in the main conduit 142 regulates a division of the flow of particulate material between the branch conduits 151, 152, as described above with respect to chute 140.

Chute 140′ includes a screen assembly 154 within each branch conduit 151, 152. In some embodiments, each screen assembly 154 includes a vibratory screen assembly. In an example, each screen assembly 154 includes a plurality of stacked decks, such as two or more decks, three or more decks, or four or more decks. In such examples, a mesh size of a screen of an upper deck is greater than a mesh size of a screen of a lower deck.

Particulate material within each branch conduit 151, 152 that passes through each screen of the screen assembly 154 progresses to the corresponding spout 180 (or spout 180′) for discharge into a container 110. Material that does not pass through each screen of the screen assembly 154 progresses to a corresponding collection zone 156 within each branch conduit 151, 152. Material within each collection zone 156 may be accessed for removal by opening a corresponding access hatch 158.

Returning to FIG. 2B, the particulate material handling system 100 includes a dust extraction system 210. The exhaust line 214 from each spout 180 (or spout 180′) is coupled to a dust collector 220. As illustrated, in some embodiments, an exhaust line 216 from the feed conveyor 130 is also coupled to the duct collector 220. In some embodiments, the dust collector 220 includes a cyclone that separates dust and other particles from the air entering the dust collector 220. In some embodiments, the dust collector 220 includes a filter that separates dust and other particles from the air entering the dust collector 220. In some embodiments, the dust collector 220 includes a filter that separates dust and other small particles from larger particles. In some examples, the larger particles are routed back to the chute 140 via a return line 22 from the dust collector 220. In some embodiments, the flow of air into and through the dust collector 220 is facilitated at least in part by a fan 224 coupled to an exhaust 226 of the dust collector 220.

As illustrated in FIGS. 1 and 2B, the chute 140 is mounted to a frame 230. The frame 230 includes legs 232. In some embodiments, the legs 232 are configured to telescope between retracted and extended positions. In an example, the frame 230 and chute 140 are transported as a unit when the legs 232 are in a retracted position, and are set up to an operational configuration at a work site by telescoping the legs 232 to an extended position. Additionally, or alternatively, telescoping the legs 232 permits an elevation of the chute 140 above a ground surface at a work site to be adjusted, such as to accommodate containers 110 of differing sizes below the chute 140, or to accommodate a slope or unevenness of the ground surface.

In some embodiments, the frame 230 with the chute 140 are together configured to facilitate transportation and to facilitate deployment at a work site. In an example, the frame 230 with the chute 140 are together mounted on a skid. In another example, the frame 230 with the chute 140 are together mounted on a wheeled chassis. In another example, the frame 230 with the chute 140 are together mounted on a trailer.

When assembled at a work site, the chute 140 is positioned above a transfer conveyor system 250. The transfer conveyor system 250 includes one or more transfer conveyor 252. In one or more embodiments, each transfer conveyor 252 includes a pair of parallel chains 254 or tracks, each parallel chain 254 or track being driven around a loop.

In some embodiments, the transfer conveyor system 250 is configured to facilitate transportation and to facilitate deployment at a work site. In an example, the transfer conveyor system 250 is mounted on a skid. In another example, the transfer conveyor system 250 is mounted on a wheeled chassis. In another example, the transfer conveyor system 250 is mounted on a trailer.

In some embodiments, the transfer conveyor system 250 and the frame 230 with the chute 140 are together configured to facilitate transportation and to facilitate deployment at a work site. In an example, the transfer conveyor system 250 and the frame 230 with the chute 140 are together mounted on a skid. In another example, the transfer conveyor system 250 and the frame 230 with the chute 140 are together mounted on a wheeled chassis. In another example, the transfer conveyor system 250 and the frame 230 with the chute 140 are together mounted on a trailer.

The one or more transfer conveyor 252 moves containers 110 relative to the chute 140. As illustrated, one or more cameras 104 can be positioned to enable an operator to visually monitor the operation of moving a container 110 on the transfer conveyor system 250 and/or discharging particulate material from the chute 140 into a container 110.

In some embodiments, the operations of the particulate material handling system 100 are monitored and controlled via a controller 200. In an example, the controller 200 is housed in a control cabin. The control cabin may be a stand-alone unit, or may be mounted adjacent to any one of the unloader 120, the feed conveyor 130, or the chute 140. It is contemplated that the controller 200 includes a central processing unit (CPU), a memory containing instructions, and support circuits for the CPU. The controller 200 may be of any form of a general-purpose computer processor that is used in an industrial setting for controlling various conveyors, valves, and equipment and/or sub-processors thereon or therein.

The memory, or non-transitory computer readable medium, is one or more of a readily available memory such as random access memory (RAM), read only memory (ROM), floppy disk, hard disk, flash drive, or any other form of digital storage, local or remote. The support circuits are coupled to the CPU for supporting the CPU (a processor). The support circuits include cache, power supplies, clock circuits, input/output circuitry and subsystems, and the like. Operations and operating parameters are stored in the memory as a software routine that is executed or invoked to turn the controller 200 into a specific purpose controller to control the operations of any of the components of the particulate material handling system 100. The controller 200 is configured to conduct any of the operations described herein. The instructions stored on the memory, when executed, cause one or more of the operations described herein to be conducted.

In some embodiments, data from any sensor or component associated with the particulate material handling system 100 may be used to provide feedback to the controller 200. In some embodiments, data of electrical current draw of any component associated with the particulate material handling system 100 may be used to provide feedback to the controller 200. The controller 200 uses the data so provided as an input to process commands addressed to any component associated with the particulate material handling system 100.

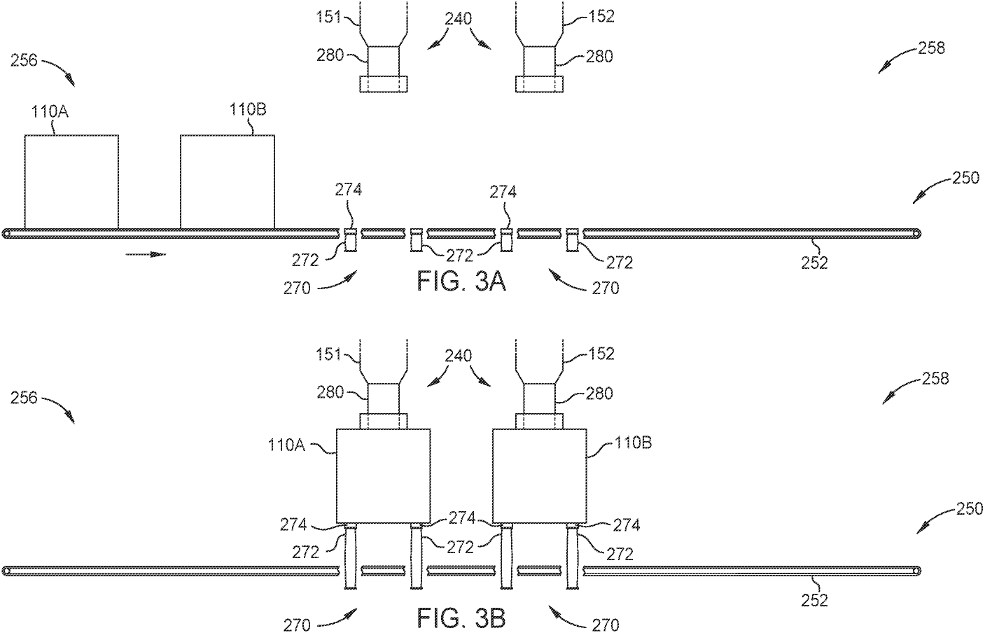

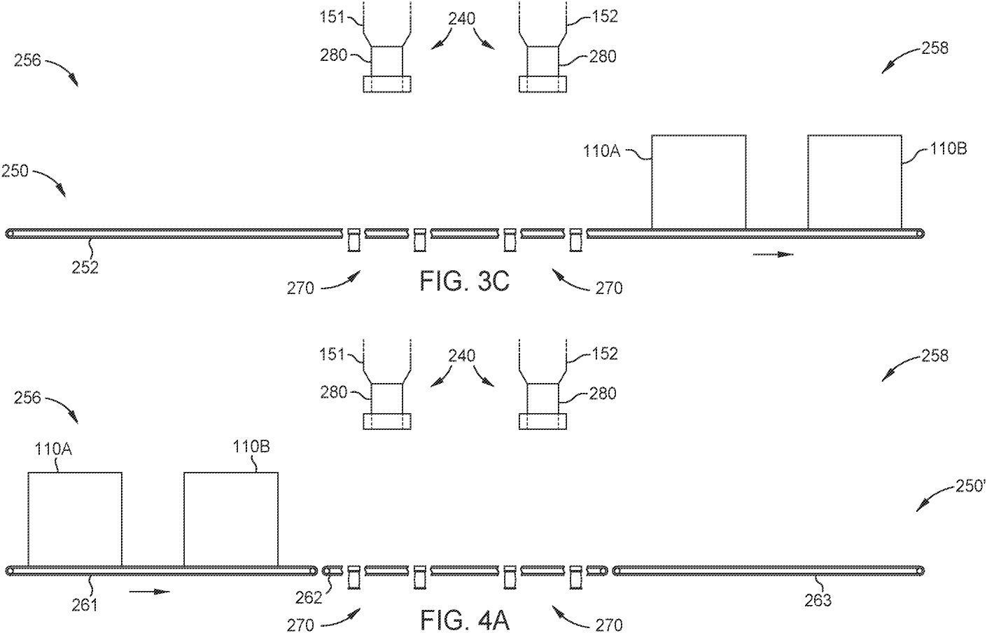

FIGS. 3A-3C schematically illustrate an exemplary operation of the transfer conveyor system 250. In the illustrated example, the transfer conveyor system 250 includes a single transfer conveyor 252, configured as described above. The transfer conveyor 252 extends from a container loading station 256 at a side of the chute 240, below the chute 240, and to a container offloading station 258 at another side of the chute 240 opposite to the side at which the container loading station 256 is located. Chute 240 represents any of the embodiments of chute 140 or chute 140′. Also depicted are spouts 280 of chute 240. Spouts 280 represent any of the embodiments of spout 180 or spout 180′.

In FIG. 3A, two containers 110A, 110B are positioned on the transfer conveyor 252 at the container loading station 256. In some embodiments, the containers 110A, 110B are positioned at a predetermined separation. The predetermined separation may include a range of distance values. In an example, a first container 110A (or 110B) is placed on the transfer conveyor 252 at a reference location. Then the transfer conveyor 252 is operated to move the first container 110A (or 110B) a predetermined distance equal to the predetermined separation from the reference location. Then a second container 110B (or 110A) is placed on the transfer conveyor 252 at the reference location.

In another example, the first container 110A (or 110B) is placed on the transfer conveyor 252 at a reference location. Then the transfer conveyor 252 is operated to move the first container 110A (or 110B) a predetermined distance from the reference location. Then the second container 110B (or 110A) is positioned above the transfer conveyor 252, and the separation between the first container 110A and the second container 110B is determined, such as by a laser distance measurer or by correlating with a fixed marker. If necessary, the transfer conveyor is operated while the second container 110B (or 110A) is held stationary in order to adjust the separation between the first container 110A and the second container 110B. Once the separation between the containers 110A, 110B is determined to be within the range of values of the predetermined separation, the second container 110B (or 110A) is placed onto the transfer conveyor 252.

In some embodiments, sensors, such as cameras 104 (FIG. 2B) may be used to observe and identify the positioning of, and separation between, the containers 110A, 110B. When the separation between the containers 110A, 110B is verified as being within the range of values of the predetermined separation, the transfer conveyor 252 moves the containers 110A, 110B such that the opening 114 in the roof 112 of each container 110A, 110B is positioned below a corresponding spout 280 of the chute 240.

In embodiments in which each container 110A, 110B includes a hatch covering the opening 114 in the roof 112, the hatch is opened. In an example, an operator opens each hatch manually. In another example, the hatch is opened by a mechanism, such as a mechanical arm.

FIG. 3B schematically illustrates the positioning of the containers 110A, 110B while the containers 110A, 110B are being loaded with particulate material. Each container 110A, 110B is positioned by the transfer conveyor 252 over a corresponding lift 270. Each lift 270 is located between the parallel chains 254 (or tracks) of the transfer conveyor 252. Each lift 270 may include any suitable type of lifting mechanism 272, such as a scissor lift, hydraulic jack, pneumatic jack, fork lift, air bag lift, or the like. As illustrated, in some embodiments, each lift 270 may include more than one lifting mechanism 272. In an example, each lift 270 includes four lifting mechanisms 272, each lifting mechanism 272 positioned to engage a container 110A, 110B near a corresponding floor of the container 110A, 110B. In some embodiments, each lift 270 includes one or more load cells 274 configured to indicate a weight being supported by the lift 270. In some embodiments, the weight being supported by the lift 270 may be derived from a measurement of hydraulic or pneumatic pressure of each lifting mechanism 272. When a lift 270 is supporting a container 110A, 110B, and the container 110A, 110B is being loaded with particulate material, the weight of the container 110A, 110B is monitored during the loading operation. The monitoring of the weight of the container 110A, 110B facilitates a determination of a weight of an empty container 110A, 110B before being loaded with particulate material. Continued monitoring of the weight of the container 110A, 110B while the container 110A, 110B receives particulate material enables the establishment of a weight of particulate material being loaded into the container 110A, 110B and/or a rate of loading of particulate material into the container 110A, 110B.

Each container 110A, 110B is raised by a corresponding lift 270 off of the transfer conveyor 252. In some embodiments, each container 110A, 110B is raised until the roof 112 of each container 110A, 110B is positioned a predetermined distance from a corresponding spout 280. In some embodiments, each container 110A, 110B is raised until the roof 112 of each container 110A, 110B contacts the corresponding spout 280. In some embodiments, each container 110A, 110B is raised until the roof 112 of each container 110A, 110B contacts a shroud 192 of the corresponding spout 280. In some embodiments, each container 110A, 110B is raised until the roof 112 of each container 110A, 110B contacts and axially compresses the shroud 192 of the corresponding spout 280.

In embodiments in which each lift 270 includes more than one lifting mechanism 272, individual lifting mechanisms 272 of a lift 270 may be adjusted in order to level the container 110A, 110B being raised. In an example, individual lifting mechanisms 272 of a lift 270 are adjusted such that an entire lower end of the shroud 192 of the corresponding spout 280 contacts the roof 112 of the container 110A, 110B.

Then, a loading operation is performed in which each container 110A, 110B receives particulate material via the chute 240. The unloading conveyor 124 transfers particulate material from the hopper 122 of the unloader 120 to the feed conveyor 130 (FIGS. 1, 2A). The feed conveyor 130 delivers the particulate material into the main conduit of the chute 240 (FIGS. 1, 2A, 2B). The particulate material flows into each branch conduit 151, 152 of the chute 240, and exits through the corresponding spouts 280 into the corresponding containers 110A, 110B.

In some embodiments, during the loading operation, each container 110A, 110B may be vibrated in order to promote the distribution of the particulate material accumulating therein. In an example, the vibrating is performed by a vibration table on top of each lift 270 beneath each container 110A, 110B. In another example, one or more of the lifting mechanisms 272 are configured to perform the vibrating. In a further example, each container 110A, 110B is vibrated by engagement with a vibrating arm coupled to the frame 230.

During the loading operation, the weight of each container 110A, 110B is monitored, as described above. In some embodiments, if one container 110A, 110B becomes loaded with particulate material faster than the other container 110A, 110B, an operator, or the controller 200, may alter a positioning of the plate 162 of the flow adjuster 160 of the chute 240 in order to change the relative quantity of particulate material being delivered through the branch conduits 151, 152 to each container 110A, 110B. For example, if the flow rate of particulate material into container 110A is greater than the flow rate of particulate material into container 110B, the operator, or the controller 200, may move the plate 162 towards the first position (166, FIG. 2B) to direct a greater proportion of particulate material into branch conduit 152 than into branch conduit 151. However, in some embodiments, the containers 110A, 110B are loaded with particulate material sequentially.

Particulate material is fed into the containers 110A, 110B, and the weight of particulate material accumulating in each container 110A, 110B is monitored, as described above. In some embodiments, when the weight of particulate material in each container 110A, 110B approaches a predetermined value, the operating speed of the unloading conveyor 124 and/or the operating speed of the feed conveyor 130 is adjusted in order to avoid overflowing or overloading the containers 110A, 110B.

In some embodiments, the weight of particulate material within each container 110A, 110B as determined by each corresponding lift 270 is used to determine when to stop the flow of particulate material from the feed conveyor 130 into the chute 240. In an example, a threshold value for the weight of particulate material within each container 110A, 110B is established. When the weight of particulate material within each container 110A, 110B reaches the threshold value, an operator and/or the controller 200 reduces the operating speed of the unloading conveyor 124 and the operating speed of the feed conveyor 130 to zero. The feed of particulate material to the containers 110A, 110B slows and then ceases accordingly.

In another example, measurements (provided by scale 136) of the weight of particulate material being delivered by the feed conveyor 130 are correlated with measurements of the weight of particulate material being loaded into each container 110A, 110B. An operator and/or the controller 200 uses the correlation of measurements to calculate a trigger value for a cumulative weight of particulate material determined by the scale 136 at which to stop the feed of particulate material from the feed conveyor 130 to the chute 240. When the cumulative weight of particulate material determined by the scale 136 reaches the trigger value, the operator and/or the controller 200 reduces the operating speed of the unloading conveyor 124 and the operating speed of the feed conveyor 130 to zero. The feed of particulate material to the containers 110A, 110B slows and ceases accordingly.

During the loading operation, airborne dust from each container 110A, 110B flows out of each container 110A, 110B and into the annular space 186 between the central pipe 182/182′ and outer pipe 184 of each corresponding spout 280. The airborne dust travels into each corresponding exhaust line 214 to the dust collector 220. In some embodiments, airborne dust from the feed conveyor 130 travels to the dust collector 220 through the exhaust line 216. In some embodiments, the flow of airborne dust through the exhaust lines 214, 216 is facilitated by operating the fan 224. The dust collector 220 collects the dust, and expels relatively dust-free air via the exhaust 226. In some embodiments, particles larger than a predetermined size that are entrained in the air in the dust collector 220 are separated (such as by a filter) and returned to the chute 240 via the return line 222.

When the loading operation of the containers 110A, 110B has ended, the lifts 270 are actuated to lower the containers 110A, 110B back onto the transfer conveyor 252. FIG. 3C schematically illustrates moving the containers 110A, 110B out from under the chute 240 to the container offloading station 258 to facilitate transportation to another area of the work site. The transfer conveyor 252 moves the containers 110A, 110B to the container offloading station 258 at which the containers 110A, 110B can be picked up by a crane or a forklift.

In some embodiments, the transfer conveyor 252 does not extend to the container offloading station 258. In such embodiments, the transfer conveyor 252 moves the containers 110A, 110B back to the container loading station 256, at which the containers 110A, 110B can be picked up by a crane or a forklift.

In embodiments in which each container 110A, 110B includes a hatch covering the opening 114 in the roof 112, the hatch is closed. In an example, an operator closes each hatch manually. In another example, the hatch is closed by a mechanism, such as a mechanical arm.

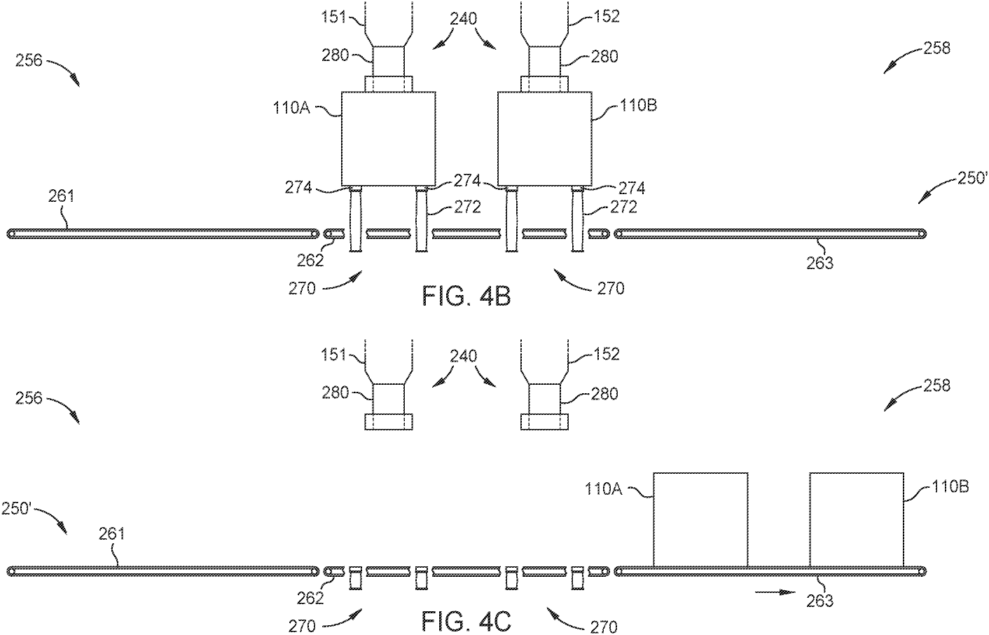

FIGS. 4A-4C schematically illustrate an exemplary operation of a transfer conveyor system 250′. Transfer conveyor system 250′ may be used in place of transfer conveyor system 250 in any embodiment of system 100 in the present disclosure. Components and operations are the same as described with respect to FIGS. 3A-3C, except for the differences highlighted below. In the illustrated example, the transfer conveyor system 250′ includes three transfer conveyors arranged in a line. Each transfer conveyor is configured as per transfer conveyor 252, described above. The first transfer conveyor 261 is located at the container loading station 256 at a side of the chute 240, and the second transfer conveyor 262 is located at least partially under the chute 240. The third transfer conveyor 263 is located at the container offloading station 258 at another side of the chute 240 opposite to the side at which the first transfer conveyor 261 is located. The first, second, and third transfer conveyors 261, 262, 263 are aligned to facilitate the transfer of containers 110A, 110B between the first transfer conveyor 261 and the second transfer conveyor 262, and between the second transfer conveyor 262 and the third transfer conveyor 263. In some embodiments, the third transfer conveyor 263 may be omitted.

In FIG. 4A, two containers 110A, 110B are positioned on the first transfer conveyor 261 at the container loading station 256. In some embodiments, the containers 110A, 110B are positioned at a predetermined distance apart. In an example, a first container 110A is positioned on the first transfer conveyor 261 at a reference location. Then the first transfer conveyor 261 is operated to move the first container 110A a predetermined distance from the reference location. Then a second container 110B is positioned on the first transfer conveyor 261 at the reference location.

The first transfer conveyor 261 moves the two containers 110A, 110B to the second transfer conveyor 262. In some embodiments, operation of the first and second transfer conveyors 261, 262 is synchronized such that the transfer of the containers 110A, 110B from the first transfer conveyor 261 to the second transfer conveyor 262 maintains the separation between the two containers at the predetermined distance. In an example, the first and second transfer conveyors 261, 262 are operated at the same speed.

In some embodiments, the separation between the containers 110A, 110B upon the first transfer conveyor 261 is different from the separation between the containers 110A, 110B when the containers 110A, 110B are positioned on the second transfer conveyor 262. In an example, the containers 110A, 110B are positioned on the first transfer conveyor 261 at a first separation. The first transfer conveyor 261 moves the containers 110A, 110B until the first container 110A is transferred to the second transfer conveyor 262. The first transfer conveyor 261 is stopped or slowed, and the second transfer conveyor 262 moves the first container 110A to a predetermined position. Then the first transfer conveyor 261 moves the second container 110B, and transfers the second container 110B to the second transfer conveyor 262 such that the containers 110A, 110B are positioned on the second transfer conveyor 262 at a second separation.

In some embodiments, sensors, such as cameras 104 (FIG. 2B) may be used to observe and identify the positioning of, and separation between, the containers 110A, 110B. When the containers 110A, 110B have been transferred to the second transfer conveyor 262, and the separation between the containers 110A, 110B is verified as being within an acceptable tolerance of a predetermined distance, the second transfer conveyor 262 moves the containers 110A, 110B such that the opening 114 in the roof 112 of each container 110A, 110B is positioned below a corresponding spout 280 of the chute 240.

In embodiments in which each container 110A, 110B includes a hatch covering the opening 114 in the roof 112, the hatch is opened. In an example, an operator opens each hatch manually. In another example, the hatch is opened by a mechanism, such as a mechanical arm.

FIG. 4B schematically illustrates the positioning of the containers 110A, 110B while the containers 110A, 110B are being loaded with particulate material. Each container 110A, 110B is positioned by the second transfer conveyor 262 over a corresponding lift 270. Each lift 270 is located between the parallel chains 254 (or tracks) of the second transfer conveyor 262. Each lift 270 is configured as described above with respect to FIG. 3B. Each container 110A, 110B is raised by a corresponding lift 270 off of the second transfer conveyor 262, as described above with respect to FIG. 3B. Then, a loading operation is performed in which each container 110A, 110B receives particulate material via the chute 240, as described above with respect to FIG. 3B.

When the loading operation of the containers 110A, 110B has ended, the lifts 270 are actuated to lower the containers 110A, 110B back onto the second transfer conveyor 262. FIG. 4C schematically illustrates moving the containers 110A, 110B out from under the chute 240 to the container offloading station 258 to facilitate transportation to another area of the work site. As illustrated, in embodiments that include the third transfer conveyor 263, the second and third transfer conveyors 262, 263 are operated to move the containers 110A, 110B from the second transfer conveyor 262 to the third transfer conveyor 263. The third transfer conveyor 263 moves the containers 110A, 110B to the container offloading station 258 at which the containers 110A, 110B can be picked up by a crane or a forklift.

In embodiments that do not include the third transfer conveyor 263, the second and first transfer conveyors 262, 261 are operated to move the containers 110A, 110B from the second transfer conveyor 262 back to the container loading station 256, at which the containers 110A, 110B can be picked up by a crane or a forklift.

In embodiments in which each container 110A, 110B includes a hatch covering the opening 114 in the roof 112, the hatch is closed. In an example, an operator closes each hatch manually. In another example, the hatch is closed by a mechanism, such as a mechanical arm.

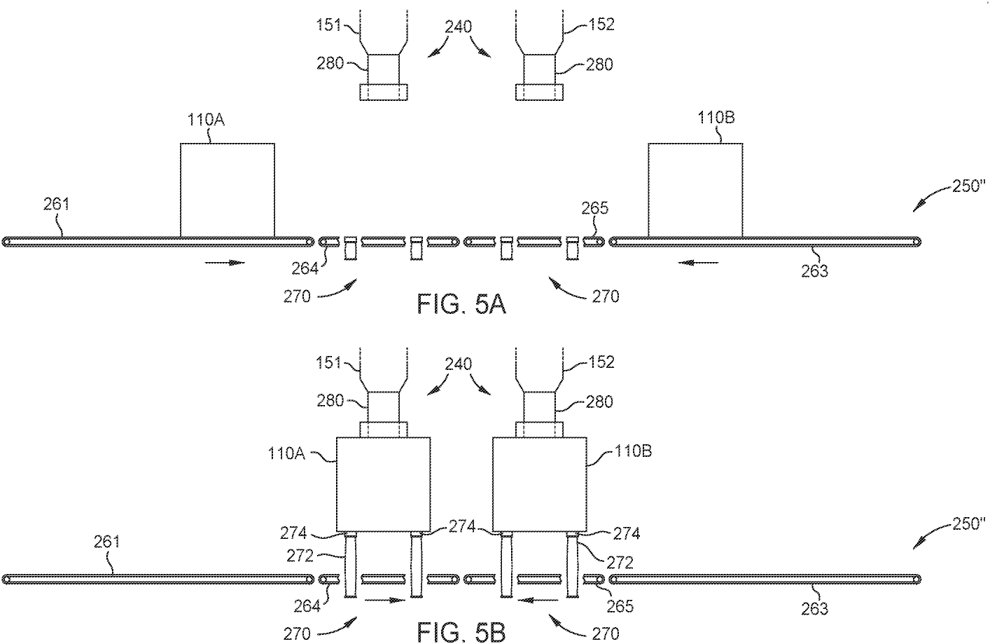

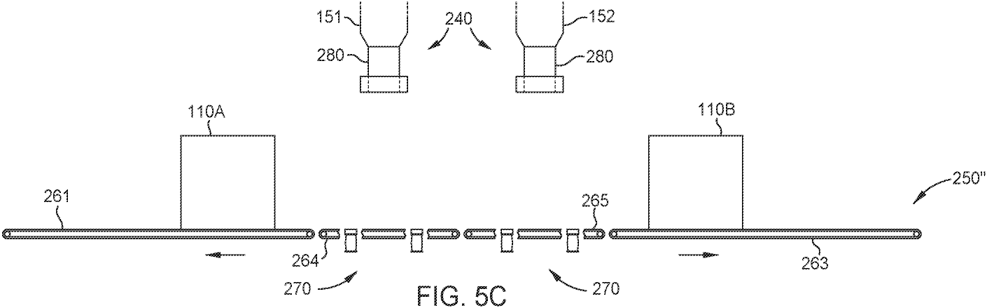

FIGS. 5A-5C schematically illustrate another exemplary operation of the transfer conveyor system 250″. Transfer conveyor system 250″ may be used in place of transfer conveyor system 250 in any embodiment of system 100 in the present disclosure. Components and operations are the same as described with respect to FIGS. 4A-4C, except for the differences highlighted below. In this example, the transfer conveyor system 250″ includes four transfer conveyors arranged in a line. Each transfer conveyor is configured as per transfer conveyor 252, described above. The first and third transfer conveyors 261, 263 are the same as per FIGS. 4A-4C. However, the second transfer conveyor 262 of FIGS. 4A-4C is replaced by two transfer conveyors-fourth transfer conveyor 264 and fifth transfer conveyor 265. The fourth transfer conveyor 264 is positioned to place container 110A beneath branch conduit 151 of the chute 240. The fifth transfer conveyor 265 is positioned to place container 110B beneath branch conduit 152 of the chute 240.

In FIG. 5A, container 110A is placed on the first transfer conveyor 261, and container 110B is placed on the third transfer conveyor 263. The first transfer conveyor 261 and fourth transfer conveyor 264 are operated to move the container 110A from the first transfer conveyor 261 to the fourth transfer conveyor 264. The third transfer conveyor 263 and fifth transfer conveyor 265 are operated to move the container 110B from the third transfer conveyor 263 to the fifth transfer conveyor 265.

FIG. 5B schematically illustrates the positioning of the containers 110A, 110B while the containers 110A, 110B are being filled with particulate material. The fourth transfer conveyor 264 positions container 110A beneath branch conduit 151 of the chute 240. The fifth transfer conveyor 265 positions container 110B beneath branch conduit 152 of the chute 240. Container 110A is positioned by the fourth transfer conveyor 264 over a corresponding lift 270. Container 110B is positioned by the fifth transfer conveyor 265 over a corresponding lift 270. Each lift 270 is located between the parallel chains 254 (or tracks) of the fourth and fifth transfer conveyors 264, 265. Each container 110A, 110B is raised by the corresponding lift 270, as described above with respect to FIG. 3B. Each container 110A, 110B is positioned with respect to the corresponding spout 280, as described above with respect to FIG. 3B. Particulate material is delivered to each container 110A, 110B, as described above with respect to FIG. 3B.

When each container 110A, 110B has received a predetermined amount of particulate material, each container 110A, 110B is lowered by the corresponding lift 270 back onto the corresponding transfer conveyor, as described above with respect to FIG. 3B. Container 110A is lowered back onto the fourth transfer conveyor 264, and container 110B is lowered back onto the fifth transfer conveyor 265.

FIG. 5C schematically illustrates moving the containers 110A, 110B out from under the chute 240 to facilitate transportation to another area of the work site. As illustrated, the fourth and first transfer conveyors 264, 261 are operated to move the container 110A from the fourth transfer conveyor 264 back to the first transfer conveyor 261. The first transfer conveyor 261 moves the container 110A to a location at which the container 110A can be picked up by a crane or a forklift. Similarly, the fifth and third transfer conveyors 265, 263 are operated to move the container 110B from the fifth transfer conveyor 265 back to the third transfer conveyor 263. The third transfer conveyor 263 moves the container 110B to a location at which the container 110B can be picked up by a crane or a forklift.

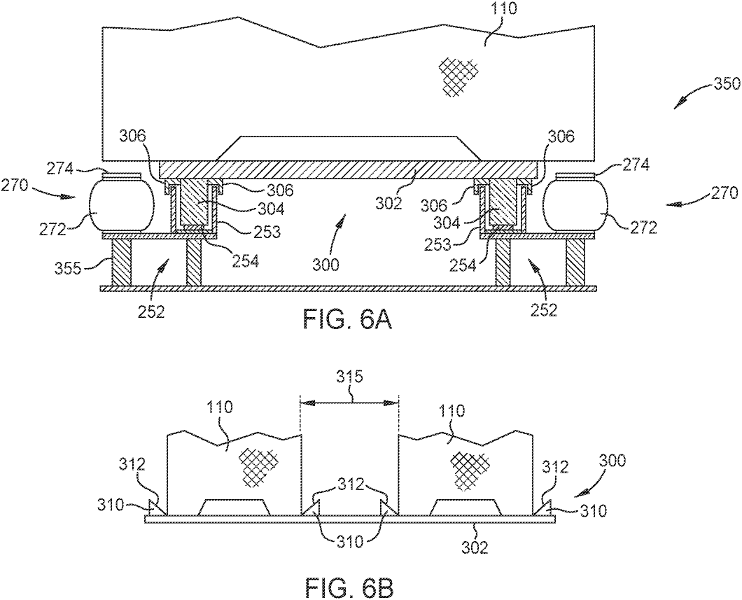

In some embodiments, the transfer conveyor system includes a shuttle, upon which one or more containers 110 may be removably mounted. FIGS. 6A and 6B schematically illustrate a transfer conveyor system 350 that incorporates a shuttle 300 with the transfer conveyor 252. FIG. 6A is a schematic end view of the transfer conveyor system 350, shown in partial cross-section. FIG. 6B is a schematic side view of a portion of a shuttle 300 with two containers 110 mounted thereon.

The shuttle 300 includes a base 302 upon which each container 110 is positioned. The base 302 includes any one or more of a plate, a frame, or other superstructure configured to bear the weight of the container(s) 110 plus the contents of container(s) 110. As illustrated in FIG. 6A, the shuttle 300 includes a channel key 304 that projects into, and rides within, an elongated channel 253 of the transfer conveyor 252. As illustrated in some embodiments, the shuttle 300 includes one or more guards 306 coupled to the base 302 and/or the channel key 304 that cover an opening of the channel 253. The one or more guards 306 hinder ingress of particulate material or other debris into the channel 253. As illustrated in FIG. 6A, in some embodiments, the transfer conveyor 252 includes two parallel channels 253. Each channel 253 receives a corresponding channel key 304 of the shuttle 300. In some embodiments, the shuttle 300 includes a plurality of channel keys 304 projecting into a channel 253.

As illustrated, in some embodiments, the transfer conveyor 252 includes the chain 254. In such embodiments, the chain 254 is disposed within each channel 253. The chain 254 is powered, such as by a motor, to move along the channel 253. Each channel key 304 is engaged with the chain 254 such that movement of the chain 254 through the channel 253 moves the shuttle 300 along the transfer conveyor 252. In some embodiments, the transfer conveyor 252 includes a track or a cable instead of the chain 254, the track or cable being powered, such as by a motor, to move along the channel 253. In such embodiments, the channel keys 304 may be engaged with the track or cable such that movement of the track or cable through the channel 253 moves the shuttle 300 along the transfer conveyor 252. Alternatively, or additionally, in some embodiments, the channel keys 304 may include wheels that contact and ride within the corresponding channel 253. In some embodiments, one or more of the wheels may be powered, such as by a motor, so as to provide a motive force for moving the shuttle 300 along the transfer conveyor 252.

In some embodiments, the channels 253 are located between lifts 270. However, in some embodiments, one or more lifts 270 may be located between the channels 253. In some embodiments, the transfer conveyor 252 and the lifts 270 are together configured to facilitate transportation and to facilitate deployment at a work site. As illustrated in FIG. 6A, in some embodiments, the transfer conveyor 252 and the lifts 270 are together mounted on a frame 355. In an example, the frame 355 is part of a skid. In another example, the frame 355 is part of wheeled chassis. In another example, the frame 355 is part of trailer.

As illustrated in FIG. 6B, in some embodiments, the shuttle 300 includes one or more guides 310 mounted on a top surface of the base 302. The one or more guides 310 assist with the positioning of each container 110 on the base 302. As illustrated, in some embodiments, the one or more guides 310 include an angled portion 312 disposed at an acute angle to the top surface of the base 302. When a container 110 is being lowered onto the base 302, engagement of the container 110 with an angled portion 312 of a guide 310 deflects the container 110 laterally. The one or more guides 310 assist with the positioning of each container 110 on the base 302 such that when each container 110 is landed on the base 302, a separation 315 between the containers corresponds to the predetermined separation, discussed above.

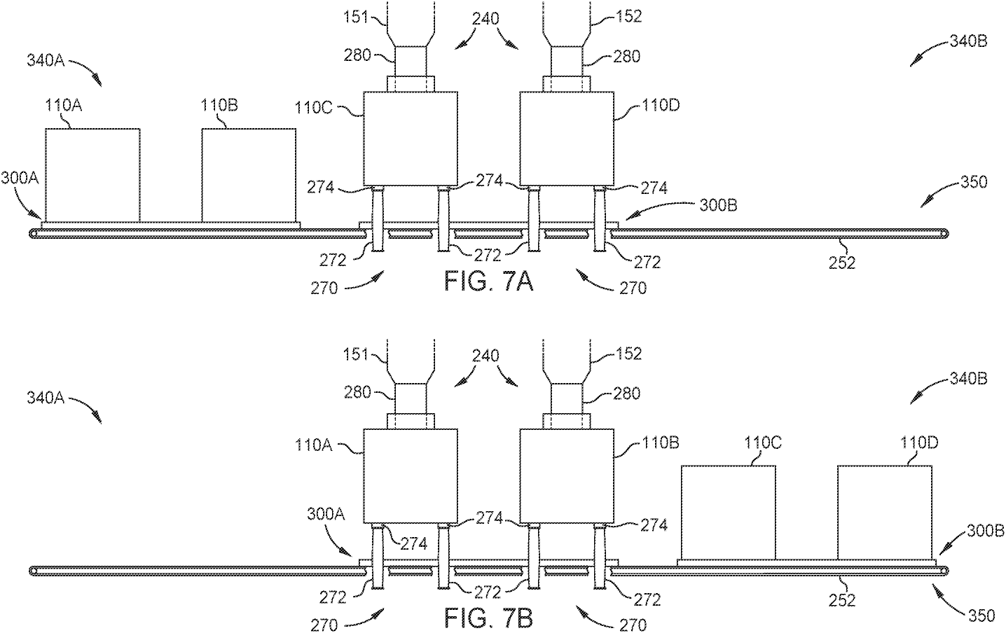

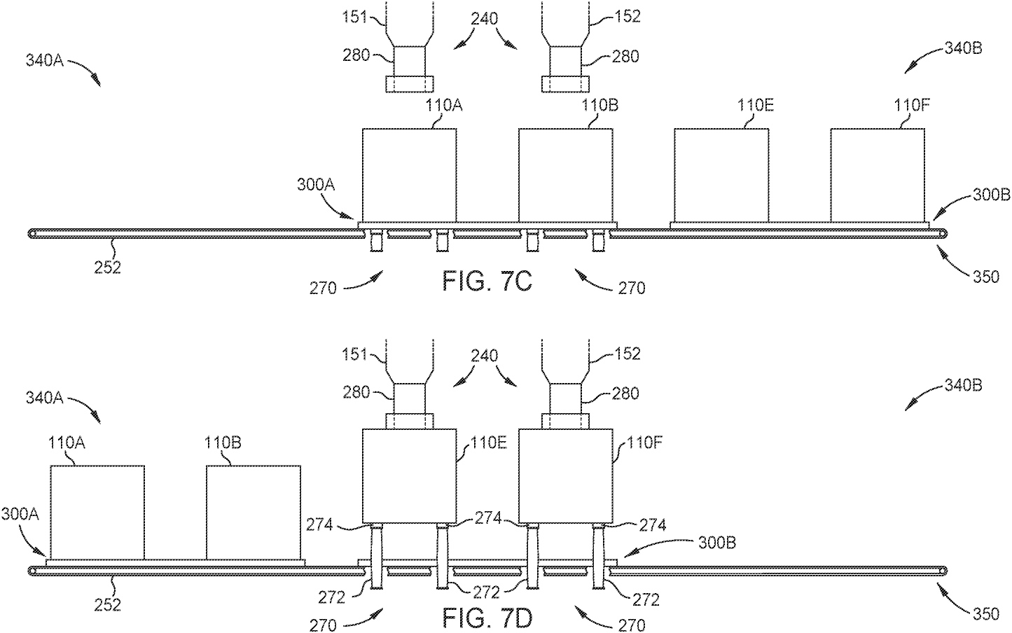

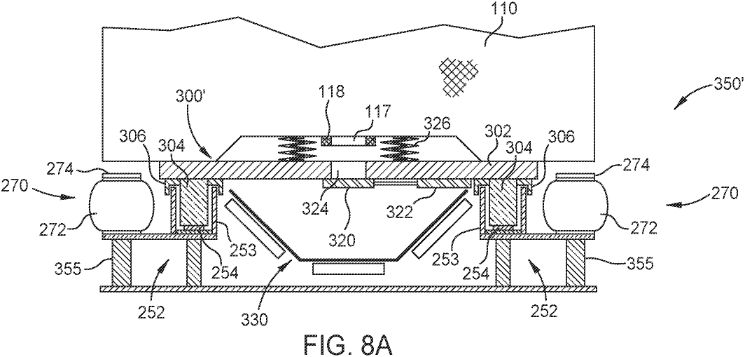

Operation of the transfer conveyor system 350 may be similar to any operation described above with respect to transfer conveyor systems 250, 250′, and 250″, except that the containers 110 are positioned on a shuttle 300. FIGS. 7A-7D schematically illustrate an example operation of the transfer conveyor system 350. Components and operations are similar to the components and operations discussed in relation to FIGS. 3A-3C, except for the differences highlighted below. The chute 240 is positioned over the transfer conveyor system 350 which includes transfer conveyor 252. The transfer conveyor 252 runs from a container exchange station 340A at one side of the chute 240 to another container exchange station 340B at an opposite side of the chute 240.

In FIG. 7A, containers 110A and 110B are waiting to receive particulate material, and are positioned on a shuttle 300A at the container exchange station 340A. Containers 110C and 110D are in the process of receiving particulate material from the chute 240, as described above with respect to FIGS. 3A-3C. Containers 110C and 110D are raised on corresponding lifts 270 beneath the chute 240, as described above with respect to FIGS. 3A-3C. The container 110C is under the first branch conduit 151 and the container 110D is under the second branch conduit 152. A shuttle 300B is positioned on the transfer conveyor 252 beneath the containers 110C and 110D.

As described above, when the filling operation of the containers 110C and 110D has ended, the lifts 270 lower the containers 110C and 110D towards the transfer conveyor 252. In this example, the lifts 270 lower the containers 110C and 110D onto the shuttle 300B. Then the transfer conveyor is operated to move the shuttle 300B with containers 110C and 110D to the container exchange station 340B, and to move the shuttle 300A with the containers 110A and 110B beneath the chute 240.

FIG. 7B shows the shuttle 300A beneath the chute 240. Containers 110A and 110B are raised off the shuttle 300A by the corresponding lifts 270 beneath the chute 240, as described above. Containers 110A and 110B are in the process of receiving particulate material from the chute 240, as described above. The container 110A is under the first branch conduit 151 and the container 110B is under the second branch conduit 152. When the filling operation of the containers 110A and 110B has ended, the lifts 270 lower the containers 110A and 110B onto the shuttle 300A.

The shuttle 300B with the containers 110C and 110D is shown at the container exchange station 340B. The containers 110C and 110D are then picked up from the shuttle 300B by a crane or forklift, and moved to another part of the work site, such as a location where the containers 110C and 110D are to release the particulate material. The shuttle 300B remains on the transfer conveyor 252. In some embodiments, the containers 110C and 110D are emptied at the other part of the work site, and then returned to the shuttle 300B. In some embodiments, two other containers are positioned on the shuttle 300B for receiving particulate material.

FIG. 7C shows the containers 110A and 110B positioned back on the shuttle 300A after receiving particulate material from the chute 240. Containers 110E and 110F have replaced containers 110C and 110D, and are shown located on the shuttle 300B at the container exchange station 340B. The transfer conveyor 252 then moves the shuttle 300A with the containers 110A and 110B to the container exchange station 340A, and moves the shuttle 300B with containers 110E and 110F beneath the chute 240.

FIG. 7D shows the shuttle 300A with the containers 110A and 110B at the container exchange station 340A, where containers 110A and 110B are then picked up from the shuttle 300A by a crane or forklift, and moved to another part of the work site. As described above, the containers 110A and 110B may then be emptied and returned to the shuttle 300A, or may be replaced by other containers on the shuttle 300A. The shuttle 300B is shown positioned beneath the containers 110C and 110D. Containers 110E and 110F are shown raised on the corresponding lifts 270 beneath the chute 240 while in the process of receiving particulate material from the chute 240. The container 110E is under the first branch conduit 151 and the container 110F is under the second branch conduit 152. The process described above with respect to FIGS. 7A-7D may be repeated for successive containers 110.

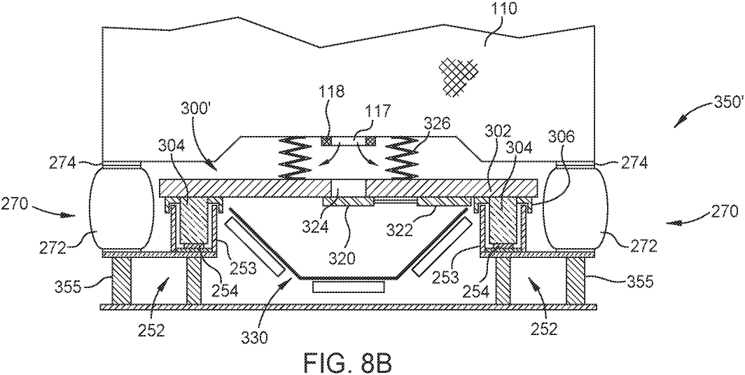

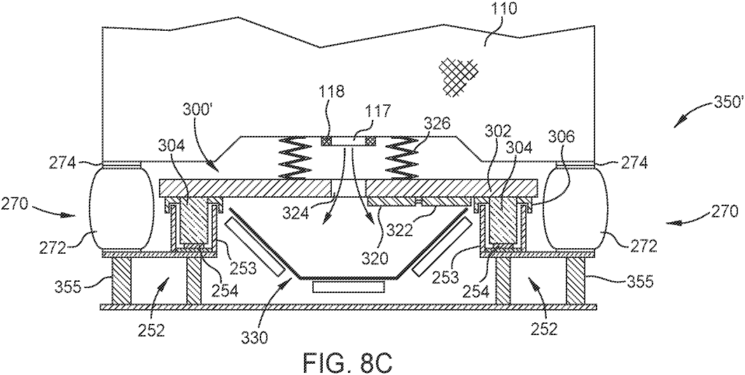

FIGS. 8A-8C schematically illustrate a transfer conveyor system 350′. The transfer conveyor system 350′ is configured similarly to the transfer conveyor system 350, and includes additional features. FIGS. 8A-8C are schematic end views of the transfer conveyor system 350′, shown in partial cross-section, during various phases of operation. Each item depicted in FIGS. 8A-8C that is common to transfer conveyor system 350 and transfer conveyor system 350′ is configured and labeled as described above with respect to FIG. 6A. Transfer conveyor 350′ includes shuttle 300′. Shuttle 300′ is configured similarly to the shuttle 300, and includes additional features. Each item depicted in FIGS. 8A-8C that is common to shuttle 300 and shuttle 300′ is configured and labeled as described above with respect to FIG. 6A. In some embodiments, shuttle 300′ includes one or more features of shuttle 300 that are depicted in FIG. 6B.

Transfer conveyor 350′ includes a provision to drain particulate material out of a container 110 while the container 110 remains with the transfer conveyor system 350′. A discharge conveyor 330 is located below the base 302 of the shuttle 300′, between the channels 253 of the transfer conveyor 252. The discharge conveyor 330 may be any suitable type of conveyor, such as a belt conveyor, pocket belt conveyor, bucket elevator, screw conveyor, pneumatic conveyor, or a tubular drag disc conveyor. The discharge conveyor is mounted to the frame 355. The discharge conveyor is configured to receive particulate material from container 110, and transport the particulate material to downstream equipment at a work site. In an example, in a fracturing operation at an oilfield work site, the discharge conveyor 330 may transport the particulate material to a blender at which the particulate material is mixed with a fracturing fluid and chemicals before being injected into a well.

FIG. 8A illustrates the transfer conveyor system 350′ while a container 110 is being moved. The lifts 270 are shown in a retracted position, out of engagement with the container 110. The container 110 includes a bottom opening 117 through which particulate material flows when the particulate material drains from the container 110. The flow of particulate material through the bottom opening 117 is controlled by a gate valve 118. Typically, the gate valve 118 is manually operated. The shuttle 300′ includes an aperture 324 in the base 302 below the gate valve 118 of the container 110. The flow of particulate material through the aperture 324 is controlled by a gate valve 320. As illustrated, in some embodiments, the gate valve 320 may be remotely operated via an actuator 322, such as hydraulic or pneumatic piston. In FIG. 8A, the gate valve 320 is shown in a closed position that blocks flow of particulate material through the aperture 324.

As illustrated, in some embodiments, a skirt 326 extends between, and contacts, the container 110 and the base 302. In some embodiments, the skirt 326 is mounted on the top surface of the base 302. The skirt 326 surrounds the bottom opening 117 and the aperture 324. The skirt 326 includes a resilient material, such as an elastomer. As illustrated, in some embodiments, the skirt 326 is configured as a bellows.

The shuttle 300′ includes at least one aperture 324, at least one skirt 326, and at least one gate valve 320 with associated actuator 322 corresponding to each container 110 of the total number of containers the shuttle 300′ may carry at any one time. In an example, the shuttle 300′ may be configured to carry two containers 110 simultaneously, and each container may include one bottom opening 117 and one gate valve 118. The shuttle 300′ may be configured with two apertures 324, two skirts 326, and two gate valves 320 with associated actuators 322, each corresponding to one of the two containers.

FIG. 8B illustrates the transfer conveyor system 350′ while a container 110 is receiving particulate material, such as from the chute 240. The lifts 270 are shown in an extended position in which the lifts 270 have raised the container 110 off of the base 302 of the shuttle 300′. The skirt 326 has deformed to remain in contact with the container 110 and with the base 302 of the shuttle 300′. The gate valve 118 of the container 110 is open, and particulate material is able to flow out of the container 110 through the bottom opening 117. However, the gate valve 320 of the shuttle 300′ is in the closed position. The gate valve 320 and the skirt 326 contain the particulate material, and promote bridging of the particulate material between the container 110 and the shuttle 300′.

FIG. 8C illustrates the transfer conveyor system 350′ while a container 110 is discharging particulate material onto the discharge conveyor 330. The lifts 270 are shown in an extended position in which the lifts 270 have raised the container 110 off of the base 302 of the shuttle 300′. The skirt 326 has deformed to remain in contact with the container 110 and with the base 302 of the shuttle 300′. The gate valve 118 of the container 110 is open, and particulate material is able to flow out of the container 110 through the bottom opening 117. The actuator 322 has adjusted the gate valve 320 of the shuttle 300′ to an open position in which particulate material is allowed to flow through the aperture 324 in the base 302. The skirt 326 guides the particulate material flowing out of the container 110 to flow through the aperture 324 onto the discharge conveyor 330.

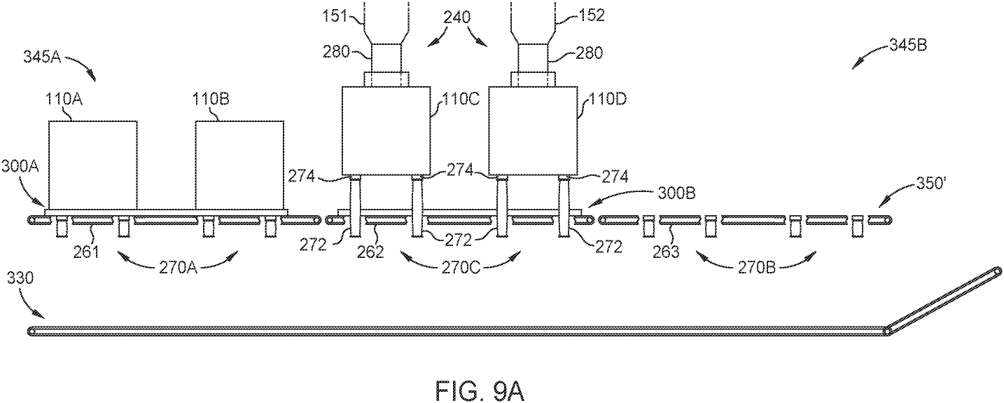

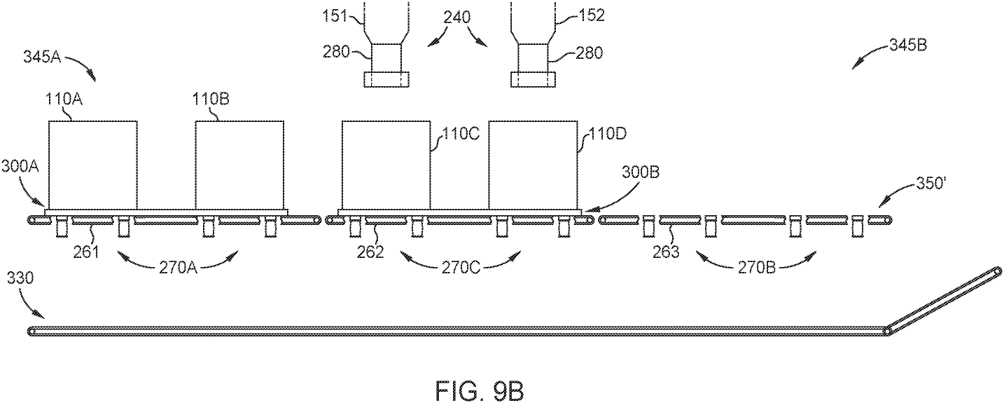

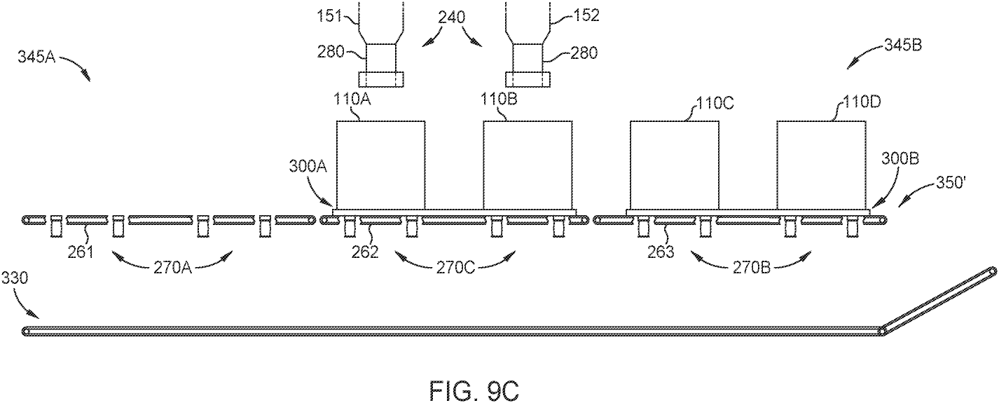

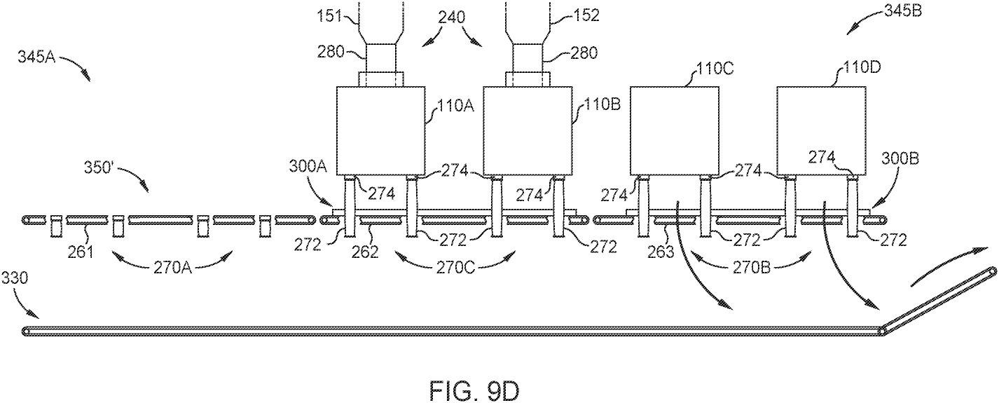

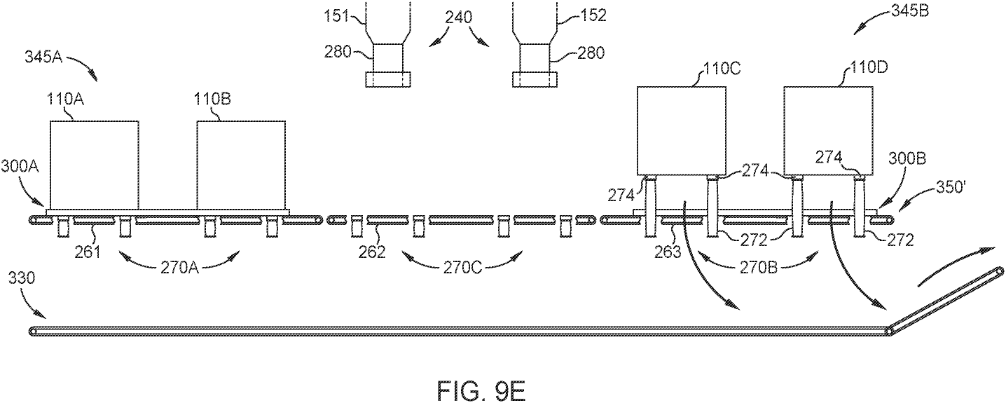

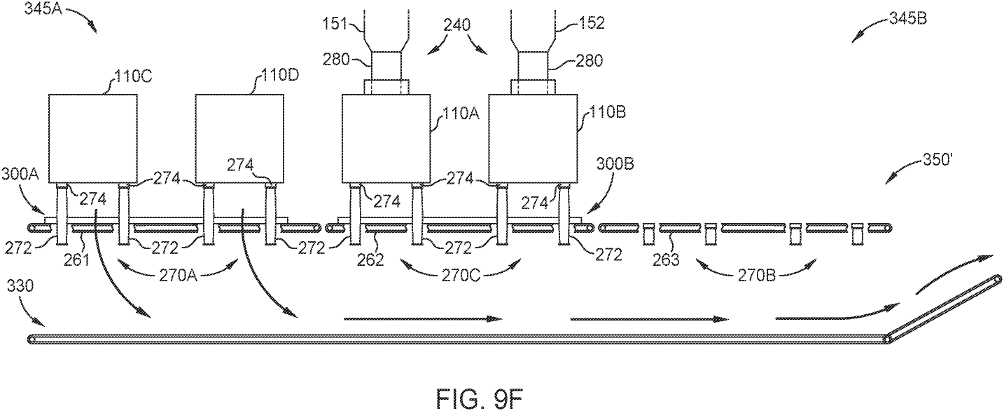

FIGS. 9A-9F schematically illustrate an example operation of the transfer conveyor system 350′. Components and operations are similar to the components and operations discussed in relation to FIGS. 7A-7D, except for the differences highlighted below. The chute 240 is positioned over the transfer conveyor system 350′. The transfer conveyor system 350′ includes the first transfer conveyor 261, the second transfer conveyor 262, and the third transfer conveyor 263 described above with respect to FIGS. 4A-4C. The first transfer conveyor 261 runs from a container discharge station 345A at one side of the chute 240 to the second transfer conveyor 262. The second transfer conveyor 262 runs beneath the chute 240 to an opposite side of the chute 240. The third transfer conveyor 263 runs from a container discharge station 345B at the opposite side of the chute 240 to the second transfer conveyor 262.

In FIG. 9A, containers 110A and 110B are waiting to receive particulate material, and are positioned at the container discharge station 345A. Containers 110C and 110D are in the process of receiving particulate material from the chute 240, as described above with respect to FIGS. 3A-3C. Containers 110C and 110D are raised on corresponding lifts 270C beneath the chute 240, as described above with respect to FIGS. 3A-3C. The container 110C is under the first branch conduit 151 and the container 110D is under the second branch conduit 152. The shuttle 300B is positioned on the second transfer conveyor 262 beneath the containers 110C and 110D.

As described above, when the filling operation of the containers 110C and 110D has ended, the lifts 270C lower the containers 110C and 110D towards the second transfer conveyor 262. FIG. 9B shows the containers 110C and 110D positioned on the shuttle 300B beneath the chute 240. Containers 110A and 110B remain on the shuttle 300A at the container discharge station 345A.

Then, the second transfer conveyor 262 and the third transfer conveyor 263 are actuated to move the shuttle 300B with the containers 110C and 110D to the container discharge station 345B. Additionally, the first transfer conveyor 261 and the second transfer conveyor 262 are actuated to move the shuttle 300A with the containers 110A and 110B to a position beneath the chute 240. FIG. 9C shows the positions of the shuttles 300A and 300B and the containers 110A, 110B, 110C, and 110D.

Then, the containers 110A and 110B are raised off the shuttle 300A by the corresponding lifts 270C beneath the chute 240, as described above. FIG. 9D shows the containers 110A and 110B in the process of receiving particulate material from the chute 240, as described above. The container 110A is under the first branch conduit 151 and the container 110B is under the second branch conduit 152. Additionally, the containers 110C and 110D are raised off the shuttle 300B by corresponding lifts 270B at the container discharge station 345B in preparation for discharging the particulate material. The raising of the containers 110C and 110D off the shuttle 300B enables the weight of discharged particulate material to be determined from measurements of load cells 274.

FIG. 9D shows the containers 110C and 110D raised off the shuttle 300B, and discharging particulate material onto the discharge conveyor 330. The gate valves 118 of each container 110C and 110D are open, and the gate valves 320 of the shuttle 300B are in the open position, as depicted in FIG. 8C. Particulate material is draining out of each container 110C and 110D, and onto the discharge conveyor 330. In some embodiments, the discharge of particulate material from the containers 110C and 110D may be promoted by vibrating the containers 110C and 110D, such as described above. The weight of particulate material drained out of each container 110C and 110D is determined from measurements made by each load cell 274 at the container discharge station 345B. The discharge conveyor 330 transports the particulate material to downstream equipment.

It is contemplated that the loading of containers 110A and 110B via the chute 240 may take less time than the discharging of particulate material from containers 110C and 110D. The containers 110A and 110B may be positioned at the container discharge station 345A while the containers 110C and 110D are discharging particulate material. The lifts 270C are actuated to lower the containers 110A and 110B back onto the shuttle 300A. Then, the first transfer conveyor 261 and the second transfer conveyor 262 are actuated to move the shuttle 300A with the containers 110A and 110B to the container discharge station 345A. FIG. 9E shows the shuttle 300A with the containers 110A and 110B at the container discharge station 345A while the containers 110C and 110D continue to discharge particulate material onto the discharge conveyor 330.

In some embodiments, particulate material may be drained from the containers 110A and 110B while the containers 110C and 110D continue to discharge particulate material onto the discharge conveyor 330. In an example, such an operation can provide an additional flow of particulate material to equipment downstream of the discharge conveyor 330.

In some embodiments, the flow of particulate material from containers 110A and 110B may be ramped up while the flow of particulate material from containers 110C and 110D slows down as containers 110C and 110D continue to empty. In an example, the gate valve 320 corresponding to one of the containers 110A and 110B may be opened while the gate valve 320 corresponding to the other of the containers 110A and 110B may remain closed. Then the gate valve 320 corresponding to the other of the containers 110A and 110B may be opened.

In some embodiments, the flow of particulate material from the containers 110A and 110B may be initiated when the flow of particulate material from the containers 110C and 110D falls below a threshold flow rate. In some embodiments, the flow of particulate material from the containers 110A and 110B may be initiated when the weight of particulate material remaining in the containers 110C and 110D falls below a threshold value.

When the discharge of particulate material from the containers 110C and 110D has finished, the containers 110C and 110D are replenished while the containers 110A and 110B are discharging particulate material onto the discharge conveyor 330. The gate valves 320 on shuttle 300B associated with the containers 110C and 110D are closed, and the lifts 270B at the container discharge station 345B are actuated to replace the containers 110C and 110D onto the shuttle 300B. Then the second transfer conveyor 262 and the third transfer conveyor 263 are actuated to move the shuttle 300B with the containers 110C and 110D to a position beneath the chute 240. Then, the containers 110C and 110D are raised off the shuttle 300A by the corresponding lifts 270C beneath the chute 240, as described above. FIG. 9F shows the containers 110C and 110D in the process of receiving particulate material from the chute 240, as described above. The container 110C is under the first branch conduit 151 and the container 110D is under the second branch conduit 152.

Additionally, the containers 110A and 110B are raised off the shuttle 300A by corresponding lifts 270A at the container discharge station 345A. As described above, the weight of particulate material discharged from the containers 110A and 110B is determined from measurements made by the corresponding load cells 274 at the container discharge station 345A. FIG. 9F shows the containers 110A and 110B discharging particulate material onto the discharge conveyor 330 while the containers 110C and 110D are receiving particulate material from the chute 240. The process described above with respect to FIGS. 9A-9F may continue such that each container 110A, 110B, 110C, and 110D repeatedly receives then discharges particulate material while remaining with the transfer conveyor system 350′.

The loading of a container with particulate material followed by the unloading of the particulate material from the container while the container is still located at the transfer conveyor provides several benefits to an operation involving the handling of bulk particulate material. One benefit is that the weight of particulate material delivered downstream by the discharge conveyor can be accurately measured. The load cells are used to monitor the weight of each container while each container is discharging particulate material, thereby enabling the weight of particulate material discharged onto the discharge conveyor to be determined.

Such measurements are useful for certain operations in which the particulate material then becomes blended with other materials. In an example, in a fracturing operation at an oilfield work site, adhering to a prescribed recipe of blending ratios of particulate material to the fracturing fluid and to the other chemicals can be critical to the success of the operation. Thus, where the discharge conveyor transports the particulate material to a blender, the quantities of fracturing fluid and chemicals to be mixed with the particulate material may be accurately determined as a result of the monitoring of the weight of particulate material discharged from each container.

Such measurements also can be correlated with the measurements made by the load cells during the loading of particulate material into each container. Such a correlation can be used for diagnostic analyses, such as the determination of how effectively each container is being drained of particulate material. The repeated handling of a container that contains a significant quantity of residual particulate material can be detrimental to the efficiency of an operation. The identification of such a container enables the initiation of remedial actions.

Another benefit is that the containers used in an operation remain with the transfer conveyor, thereby alleviating the need for operations to load and unload successive containers onto and from the transfer conveyor. The elimination, or at least the reduction, of such loading and unloading operations can provide benefits in terms of personnel safety. Furthermore, the space needed for stacking containers can be significantly reduced. In an example, for a typical oilfield fracturing operation, it is estimated that the reuse of containers while the containers remain with the transfer conveyor can provide a 75% reduction in the number of containers needed compared with a conventional fracturing operation.

The systems of the present disclosure facilitate the reception of particulate material delivered in bulk at a work site, and the distribution of the particulate material into containers at the work site. Empty containers are refilled at the work site instead of being transported back to a mine or other distribution point for refilling. The refilling and reuse of the containers at the work site results in cost savings in the total number of containers needed for an operation and savings of space that otherwise would have to be used for the stacking of empty containers.

It is contemplated that elements and features of any one disclosed embodiment may be beneficially incorporated in one or more other embodiments. Additionally, each operation described above, including the operations depicted in the Figures may be monitored and/or controlled by the controller 200. While the foregoing is directed to embodiments of the present disclosure, other and further embodiments of the disclosure may be devised without departing from the basic scope thereof, and the scope thereof is determined by the claims that follow.

What is claimed is:

1. A system for handling particulate material, the system comprising:
a chute including:
a main conduit;
a first branch conduit extending from the main conduit, and terminating at
a first spout; and
a second branch conduit extending from the main conduit, and terminating at a second spout;
a feed conveyor configured to discharge the particulate material into the main conduit;
a first lift disposed below the first spout, and configured to raise a first container toward the first spout;
a second lift disposed below the second spout, and configured to raise a second container toward the second spout; and
a transfer conveyor system configured to move the first and second containers between a first position away from the chute and a second position in which the first container is beneath the first spout and the second container is beneath the second spout.

2. The system of claim 1, wherein the chute includes a flow adjuster configured to alter a flow distribution of the particulate material between the first and second branch conduits.

3. The system of claim 1, wherein the transfer conveyor system extends from a first location at a first side of the chute to a second location beneath the chute, and comprises:
a first transfer conveyor disposed at the first location; and
a second transfer conveyor disposed at the second location and aligned with the first transfer conveyor.

4. The system of claim 1, wherein the transfer conveyor system further comprises a shuttle including a base configured to receive the first and second containers.

5. The system of claim 4, further comprising a discharge conveyor mounted below the shuttle.

6. The system of claim 1, further comprising a dust extraction system, the dust extraction system including:
a dust collector;
a first exhaust line coupling the first spout to the dust collector;
a second exhaust line coupling the second spout to the dust collector;
a third exhaust line coupling the feed conveyor to the dust collector; and
a fan coupled to an exhaust of the dust collector, the fan configured to induce a flow of air through the first, second, and third exhaust lines towards the dust collector.

7. The system of claim 6, wherein the dust extraction system further includes a return line coupled between the dust collector and the chute.

8. A system for handling containers, the system comprising:
a frame;
a transfer conveyor mounted to the frame, and including a pair of parallel elongated channels;
a shuttle disposed on the transfer conveyor, and including:
a base configured to receive a container; and
a pair of channel keys extending from the base, each channel key projecting into a corresponding one of the pair of channels; and
a lift mounted to the frame, and including first and second lift units configured to raise a container off the base and lower the container onto the base.

9. The system of claim 8, wherein the transfer conveyor further includes one of a driven chain, a driven track, or a driven cable disposed in each channel, and engaged with a corresponding one of the pair of channel keys.

10. The system of claim 8, wherein each channel key includes a wheel disposed in the corresponding channel.

11. The system of claim 10, wherein at least one of the wheels is powered to move the shuttle along the transfer conveyor.

12. The system of claim 8, wherein the shuttle further includes:
an aperture through the base; and
a gate valve coupled to the base, and associated with the aperture.

13. The system of claim 8, further comprising a discharge conveyor mounted to the frame below the shuttle.

14. The system of claim 8, wherein at least one of the first and second lift units includes a load cell.

15. A method of handling particulate material, the method comprising:
placing first and second containers onto a transfer conveyor system at a predetermined separation;
operating the transfer conveyor system to move the first container to a location beneath a first spout of a chute, and to move the second container to a location beneath a second spout of the chute;
lifting the first container off the transfer conveyor system and toward the first spout;
lifting the second container off the transfer conveyor system and toward the second spout;
discharging the particulate material from a feed conveyor into a main conduit of the chute;
diverting a first portion of the particulate material in the main conduit into a first branch conduit, and a second portion of the particulate material in the main conduit into a second branch conduit;
discharging the first portion into the first container through the first spout, and the second portion into the second container through the second spout;
monitoring a first weight of the particulate material in the first container and a second weight of the particulate material in the second container;
lowering the first and second containers back onto the transfer conveyor system; and
operating the transfer conveyor system to move the first and second containers away from the chute.

16. The method of claim 15, wherein:
the first and second containers are placed onto the transfer conveyor system at a first location at a first side of the chute; and
operating the transfer conveyor system to move the first and second containers away from the chute includes moving the first and second containers to a second location at a second side of the chute opposite the first side.

17. The method of claim 15, wherein:
the first and second containers are placed onto the transfer conveyor system at a container loading station at a side of the chute; and
operating the transfer conveyor system to move the first and second containers away from the chute includes moving the first and second containers back to the container loading station.

18. The method of claim 15, wherein placing the first and second containers onto the transfer conveyor system comprises placing the first and second containers onto a shuttle.

19. The method of claim 18, wherein operating the transfer conveyor system to move the first and second containers comprises moving the shuttle.

20. The method of claim 18, further comprising discharging the particulate material from the first and second containers onto a discharge conveyor.
